(19) United States
(12) Patent Application Publication
(10) Pub. No.: US 2013/0042776 A1
(43) Pub. Date: Feb. 21, 2013

(54) INK SUPPLY APPARATUS

(71) Applicants: Hiroyoshi Kamoda, Ibaraki (JP); Isao Komuro, Ibaraki (JP); Akehiro Kusaka, Ibaraki (JP)

(72) Inventors: Hiroyoshi Kamoda, Ibaraki (JP); Isao Komuro, Ibaraki (JP); Akehiro Kusaka, Ibaraki (JP)

(21) Appl. No.: 13/571,321

(22) Filed: Aug. 9, 2012

(30) Foreign Application Priority Data
Aug. 17, 2011 (JP) 178426/2011

(51) Int. Cl. B41F 31/02

(52) U.S. Cl. 101/367

(57) ABSTRACT

An ink supply apparatus includes an ink fountain, ink fountain keys, and an ink guide portion. The ink fountain is formed from a pair of ink dams arranged to face each other, a bottom surface, and an outer peripheral surface of an ink fountain roller so as to store ink. The ink fountain keys that form gaps between the outer peripheral surface of the ink fountain roller and the ink fountain keys to extract the ink stored in the ink fountain. The ink guide portion projects from a distal end of each of the ink fountain keys toward the ink fountain roller so as to guide the ink extracted from the ink fountain to the ink fountain roller.

### BACKGROUND OF THE INVENTION

The present invention relates to an ink supply apparatus for supplying ink to a printing press.

As described in Japanese Patent Laid-Open No. 2007-237537, a conventional ink supply apparatus includes an ink fountain which is surrounded by a bottom plate fixed on the upper surface of a fountain key support base, a pair of ink dams standing on the two ends of the fountain key support base in the widthwise direction, a plurality of ink fountain keys juxtaposed in the axis direction of an ink fountain roller to be close to its outer peripheral surface, and the outer peripheral surface of the ink fountain roller. Ink in the ink fountain is extracted from a gap formed between the ink fountain keys and the ink fountain roller to the ink fountain roller side. The extracted ink is evened by an oscillating roller facing (contacting) the ink fountain roller and then supplied to the printing press side.

In the above-described conventional ink supply apparatus, the ink is wasted because it drops in a large amount from the gap formed between the ink fountain keys and the ink fountain roller at the time of printing. In addition, when the ink has solidified and made a pile on the ink pan for collecting dropping ink, the ink that has piled up is fed to the printing cylinders via the oscillating roller, resulting in degradation in the printing quality. To prevent this, the ink pan needs to be cleaned each time, and the ink pan cleaning operation puts an enormous load. Furthermore, the printing press needs to be stopped every time the cleaning operation is performed. For this reason, the degree of capacity utilization of the printing press lowers.

### SUMMARY OF THE INVENTION

It is an object of the present invention to provide an ink supply apparatus that reduces the load of a cleaning operation by decreasing an amount of ink dropping from a gap formed between ink fountain keys and an ink fountain roller at the time of printing.

In order to achieve the above-described object, according to the present invention, there is provided an ink supply apparatus comprising an ink fountain that is formed from a pair of ink dams arranged to face each other, a bottom surface, and an outer peripheral surface of an ink fountain roller and stores ink, ink fountain keys that form gaps between the outer peripheral surface of the ink fountain roller and the ink fountain keys to extract the ink stored in the ink fountain, and an ink guide portion that projects from a distal end of each of the ink fountain keys toward the ink fountain roller and guides the ink extracted from the ink fountain to the ink fountain roller.

According to the present invention, since the ink guide portion for guiding ink to the ink fountain roller is provided, the ink transfer time from the ink fountain to the ink fountain roller becomes long, and the amount of dropping ink that cannot completely be transferred to the outer peripheral surface of the ink fountain roller decreases. As a result, the load of the cleaning operation of the ink pan for collecting the dropping ink is reduced. In addition, the cleaning interval is prolonged, and the degree of capacity utilization of the printing press is improved.

Additionally, since the ink that drops from the ink guide portion is partially collected by a roller, the amount of ink collected by the ink pan further decreases. As a result, the load of the cleaning operation of the ink pan is reduced. In addition, the ink collected by the ink pan is never fed to the printing press, and the printing quality is improved.

### BRIEF DESCRIPTION OF THE DRAWINGS

FIG. 1 is a side view of an ink supply apparatus according to the first embodiment of the present invention;

FIG. 2 is an enlarged side view of main part of the ink supply apparatus shown in FIG. 1;

FIG. 3 is a side view of an ink supply apparatus according to the second embodiment of the present invention;

FIG. 4 is an enlarged side view of main part of the ink supply apparatus shown in FIG. 2; and

FIG. 5 is a schematic view for explaining the function of an oscillating roller according to the first and second embodiments of the present invention.

### DESCRIPTION OF THE PREFERRED EMBODIMENTS

Details of the present invention will now be described with reference to the accompanying drawings.

### First Embodiment

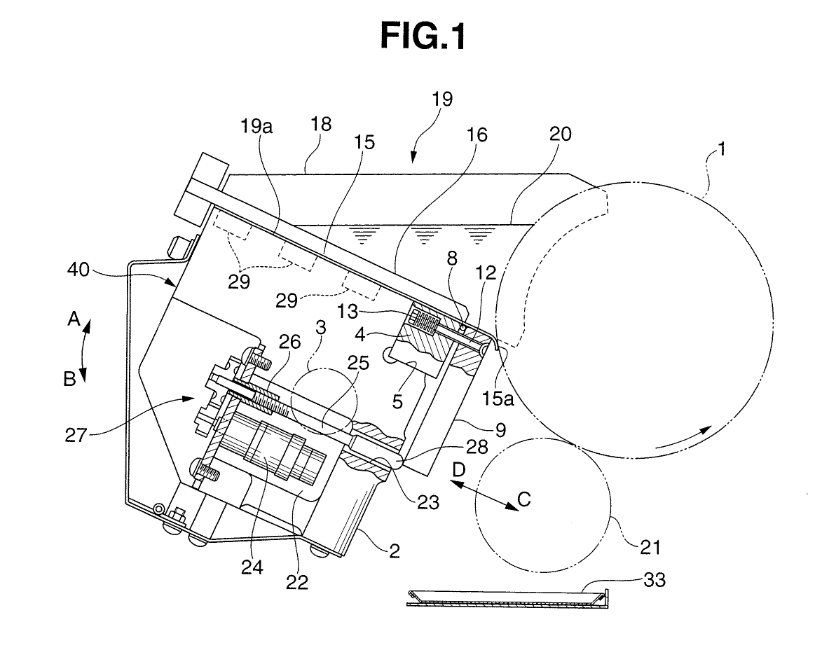

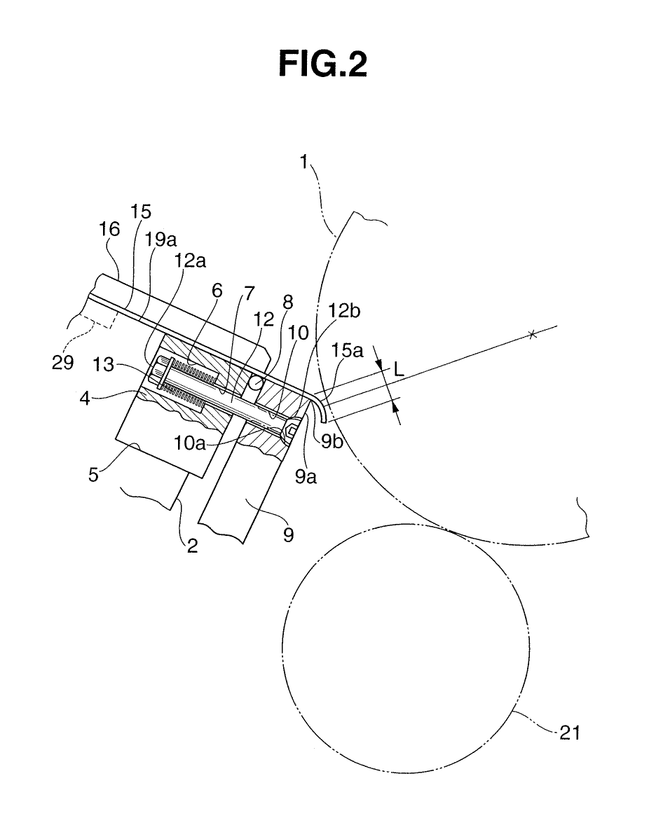

The first embodiment of the present invention will be described first with reference to FIGS. 1 and 2. An ink fountain roller 1 according to this embodiment is rotatably supported between a pair of machine base frames (not shown) and rotates in a direction from ink fountain keys 9 to an oscillating roller 21 to be described later (counterclockwise in FIG. 1) during an operation. As shown in FIG. 1, an ink fountain key support base 2 that is the ink fountain main body is provided on the rear side of the ink fountain roller 1 and runs slightly longer than the cylinder of the ink fountain roller 1. A support pin 3 is embedded in the machine base frames. The ink fountain key support base 2 is supported to pivot in directions to move close to and separate from the ink fountain roller 1, that is, clockwise and counterclockwise (the directions of arrows A and B) in FIG. 2 about the support pin 3 serving as the pivotal center.

A holding bar 4 is attached to a groove 5 formed in the upper end of the ink fountain key support base 2 on the front end side and runs in the axis direction of the ink fountain roller 1. The holding bar 4 has almost the same length as that of the cylinder of the ink fountain roller 1. A ink fountain key support base unit 40 comprises the ink fountain key support base 2 and the holding bar 4. As shown in FIG. 2, a large-diameter hole 6 and a small-diameter hole 7 communicating with the large-diameter hole 6 are formed in the holding bar 4 and extend through in the back-and-forth direction. A plurality of pairs of large-diameter holes 6 and small-diameter holes 7 are provided in the axis direction of the ink fountain roller 1 in correspondence with a plurality of ink fountain keys 9 to be described later.

A fulcrum pin 8 has an almost cylindrical long slender shape and the same length as that of the holding bar 4. The plurality of prismatic ink fountain keys 9 are juxtaposed in the axis direction of the ink fountain roller 1 to be close to its outer peripheral surface. The total width of the plurality of ink fountain keys 9 is the same as the cylinder length of the ink fountain roller 1. Each ink fountain key 9 has a through hole 10 having the same diameter as that of the small-diameter hole 7 formed in the holding bar 4. A concave portion 10a having an almost semispherical shape is formed at one opening edge of the through hole 10.

An ink fountain key open pin 12 is movably inserted into the small-diameter hole 7 of the holding bar 4 and the through hole 10 of the ink fountain key 9. The ink fountain key open pin 12 has a head portion 12a at one end, and at the other end, an almost semispherical swelled portion 12b that engages with the concave portion 10a of the ink fountain key 9. A coned disc spring 13 in a compressed state is placed between the head portion 12a of the ink fountain key open pin 12 and the bottom portion of the large-diameter hole 6 of the holding bar 4. The ink fountain key 9 is swingably supported by the holding bar 4 based on the spring force of the coned disc spring 13. In this arrangement, when the ink fountain key open pin 12 is biased by the spring force of the coned disc spring 13 in a direction to separate from the ink fountain roller 1, the ink fountain key 9 swings in a direction separate from the outer peripheral surface of the ink fountain roller 1, that is, clockwise in FIG. 1 about the fulcrum pin 8 serving as the pivotal center.

As shown in FIG. 1, a plurality of magnets 29 are buried in the ink fountain key support base 2. A film-like waterproof sheet 15 that covers a bottom surface 19a of the ink fountain 19 (the upper surfaces of the ink fountain key support base 2, the holding bar 4, and the ink fountain keys 9) is fixed to the upper surface of the ink fountain key support base 2 by a fixed member 16 that is made of a magnetic metal and magnetically attracted by and engaged with the magnets 29. That is, the fixed member 16 is placed on the sheet 15 that wholly covers the bottom surface 19a of the ink fountain 19 and magnetically fixed on the bottom surface 19a of the ink fountain 19. The sheet 15 is thus sandwiched and fixed between the fixed member 16 and the bottom surface 19a of the ink fountain 19.

The fixed member 16 is formed from one plate that wholly covers the bottom surface 19a of the ink fountain 19 except (while exposing) the ink fountain keys 9. The fixed member 16 has the same length as the distance between the pair of ink dams 18 in the longitudinal direction, and a width to cover a portion from the rear end of the upper surface of the ink fountain key support base 2 to the front end of the upper surface of the holding bar 4 in the widthwise direction. A grip (not shown) for detachment is attached to the rear end of the fixed member 16.

Note that the magnets 29 may be buried in the holding bar 4. That is, the magnets 29 may be buried in at least one of the ink fountain key support base and the holding bar 4. Further, the sheet 15 can similarly be fixed by making the while ink fountain key support base 2 using a magnetic metal, burying a magnetic metal in the holding bar 4, or making the fixed member 16 using a magnet.

As shown in FIG. 2, the sheet 15 covers the upper surface of the ink fountain key 9 as well and projects by a length L (5 to 15 mm) from the end face 9a of the ink fountain key 9 to the side of the ink fountain roller 1. The projecting portion of the sheet 15 forms an ink guide portion 15a having a width almost equal to the cylinder length of the ink fountain roller 1. The distal end of the sheet 15 that forms the ink guide portion 15a is a free end. Since the sheet 15 is flexible, the ink guide portion 15a bends and hangs downward by its own weight. The outer bent surface faces the outer peripheral surface of the ink fountain roller 1. A small gap is formed between the outer bent surface of the ink guide portion 15a and the outer peripheral surface of the ink fountain roller 1.

As shown in FIG. 1, a pair of ink dams 18 each having a triangular shape when viewed from a side stand on the two ends of the ink fountain key support base 2 in the axis direction of the ink fountain roller 1 in state of facing each other. Ink 20 is stored in an ink fountain 19 surrounded by the pair of ink dams 18, the fixed member 16, the sheet 15, and the outer peripheral surface of the ink fountain roller 1. The oscillating roller 21 is disposed immediately under the ink guide portion 15a of the sheet 15 and contacts the ink fountain roller 1. The oscillating roller 21 evens, in the axis direction, the ink 20 extracted from the ink fountain roller 1 and then supplies the ink 20 to a roller group (not shown) on the downstream side. An ink pan 33 for collecting the ink that has dropped from the oscillating roller 21 is arranged immediately under the oscillating roller 21.

A concave portion 22 having an opening on the rear side runs under the ink fountain key support base 2 between its two ends. A plurality of through holes 23 communicating with the concave portion 22 and extending through the front end of the ink fountain key support base 2 are provided in correspondence with the plurality of ink fountain keys 9. A plurality of motors 24 are provided in the concave portion 22 in correspondence with the plurality of ink fountain keys 9.

An ink fountain key open/close screw rod 25 threadably engages with a sleeve 26 fixed to the ink fountain key support base 2. The rotation of the motor 24 is transferred to the ink fountain key open/close screw rod 25 via a gear train 27. A press member 28 inserted through the through hole 23 of the ink fountain key support base 2 is attached to the front end of the ink fountain key open/close screw rod 25. The lower end of each ink fountain key 9 comes into contact with the distal end of the press member 28.

In this arrangement, when the motor 24 is driven in one direction, the ink fountain key open/close screw rod 25 rotates via the gear train 27. The ink fountain key open/close screw rod 25 moves in the direction of an arrow C in FIG. 1 due to the spring action to the sleeve 26, and the press member 28 moves forward out of the through hole 23. As the press member 28 moves forward, the ink fountain key 9 swings counterclockwise against the spring force of the coned disc spring 13 using the fulcrum pin 8 as the fulcrum of swing. The gap formed between the outer peripheral surface of the ink fountain roller 1 and an angled portion 9b of the ink fountain key 9 thus becomes smaller to adjust and decrease the ink extraction amount (supply amount) from the ink fountain 19.

On the other hand, when the motor 24 is driven in the other direction, the ink fountain key open/close screw rod 25 rotates in a reverse direction via the gear train 27. The ink fountain key open/close screw rod 25 moves in the direction of an arrow D in FIG. 1 due to the spring action to the sleeve 26, and the press member 28 retracts into the through hole 23. As the press member 28 retracts, the ink fountain key 9 swings clockwise by the spring force of the coned disc spring 13 using the fulcrum pin 8 as the fulcrum of swing. The gap formed between the outer peripheral surface of the ink fountain roller 1 and the angled portion 9b of the ink fountain key 9 thus becomes larger to adjust and increase the ink extraction amount (supply amount) from the ink fountain 19.

The ink extracted from the ink fountain 19 is guided to the ink guide portion 15a projecting from the end face 9a of the ink fountain key 9 toward the ink fountain roller 1. At this time, the ink guide portion 15a having the length L from the angled portion 9b at an ink transfer position faces the outer peripheral surface of the ink fountain roller 1. Hence, the ink is guided to the ink guide portion 15a in an amount corresponding to its area, and the time of ink transfer from the ink guide portion 15a to the ink fountain roller 1 becomes long. As a result, the ink transfer amount from the ink guide portion 15a to the ink fountain roller 1 increases, and the amount of ink that drops from the sheet 15 largely decreases. The ink guide portion 15a is drawn to the ink fountain roller 1 due to the adhesion of the ink. Consequently, the ink transfer amount from the ink guide portion 15a to the ink fountain roller 1 increases.

Especially, upon intaglio printing in which the ink has a relatively high viscosity, and the amount of ink that drops at the time of transfer from the ink fountain 19 to the ink fountain roller 1 is large, the dropping ink amount conspicuously decreases. When cleaning the ink fountain 19, the sheet 15 can be detached from the ink fountain 19 by releasing the fixed members 16 from the magnetic fixing of the magnets. This allows to easily clean the ink fountain 19 in a short time.

### Second Embodiment

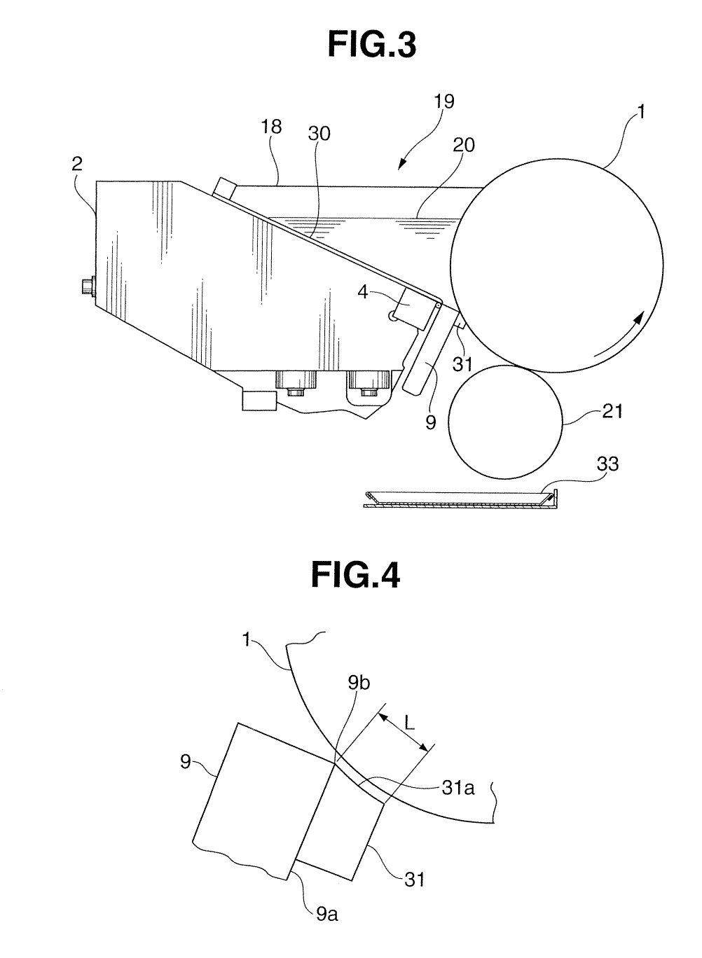

The second embodiment of the present invention will be described next with reference to FIGS. 3 and 4. In the second embodiment, not the sheet 15 but a bottom plate 30 formed from a thin steel plate is magnetically attracted by magnets (not shown) buried in an ink fountain key support base 2 and a holding bar 4, unlike the first embodiment. In this embodiment, ink 20 is stored in an ink fountain 19 surrounded by the bottom plate 30, ink fountain keys 9, a pair of ink dams 18, and the outer peripheral surface of an ink fountain roller 1.

In the second embodiment, an ink guide member 31 having an almost rectangular parallelepiped shape and the same length as the width of the ink fountain key 9 is integrally fixed to an end face 9a of each ink fountain key 9, as shown in FIG. 4. The upper surface of the ink guide member 31 is provided with a circular ink guide portion 31a having one end starting from an angled portion 9b and facing the outer peripheral surface of the ink fountain roller 1 at a predetermined gap. The ink guide portion 31a has a concentric surface having a length L (5 to 15 mm) and faces the outer peripheral surface of the ink fountain roller 1 at an equal interval. An oscillating roller 21 is arranged immediately under the ink guide portion 31a, as in the first embodiment.

In the ink supply apparatus of the second embodiment as well, the ink guide portion 31a from the angled portion 9b at an ink transfer position faces the outer peripheral surface of the ink fountain roller 1. Hence, the ink transfer amount from the ink fountain 19 to the ink fountain roller 1 increases, and the amount of ink that drops from the ink guide portion 31a decreases, as in the first embodiment.

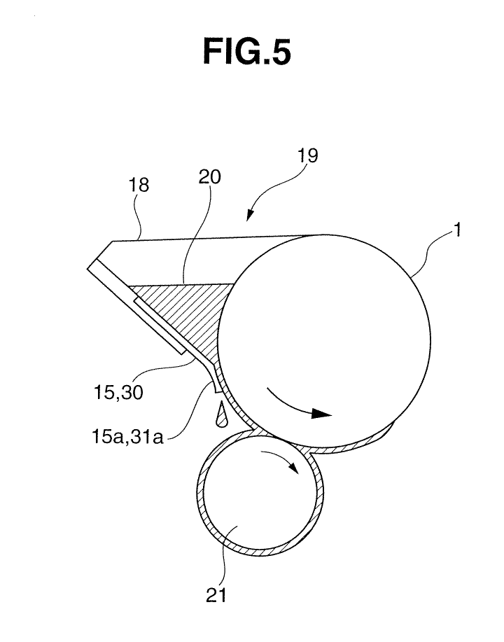

The oscillating roller 21 according to the first and second embodiments will be described next with reference to FIG. 5. Focusing on the fact that the amount of ink that drops from the ink guide portion 15a or 31a decreases, the oscillating roller 21 that faces (contacts) the ink fountain roller 1 and evens, in the axis direction, the ink 20 sticking to the ink fountain roller 1 is arranged immediately under the ink guide portion 15a or 31a.

With this arrangement, the ink that has dropped from the ink guide portion 15a or 31a to the oscillating roller 21 is collected by the oscillating roller 21 and fed to the printing cylinders. However, since the amount of ink collected for reuse is smaller, the printing quality is not adversely affected. In addition, since the oscillating roller 21 partially collects the dropping ink, the amount of ink collected by the ink pan 33 further decreases. Hence, the cleaning interval of the ink pan 33 is prolonged, and the load of the cleaning operation is reduced. Since the ink collected by the ink pan 33 is never fed to the printing cylinders again via the oscillating roller 21, the printing quality is improved.

In the above-described embodiments, the oscillating roller 21 is provided between the ink guide portion 15a or 31a and the ink pan 33. However, the ink pan 33 may be provided immediately under the ink guide portion 15a or 31a without providing the oscillating roller 21. In this case as well, since the amount of ink dropping from the ink guide portion 15a or 31a decreases, it is possible to reduce the load of the cleaning operation and improve the degree of capacity utilization of the printing press. The oscillating roller 21 is provided immediately under the ink guide portion 15a or 31a. A roller such as a distribution roller may be provided instead. In the second embodiment, the ink guide member 31 is fixed to the end face 9a as a member separated from the ink fountain key 9. However, the ink guide member 31 may be integrated with the ink fountain key 9.

What is claimed is:

1. An ink supply apparatus comprising:
an ink fountain that is formed from a pair of ink dams arranged to face each other, a bottom surface, and an outer peripheral surface of an ink fountain roller and stores ink;
ink fountain keys that form gaps between the outer peripheral surface of the ink fountain roller and the ink fountain keys to extract the ink stored in the ink fountain; and
an ink guide portion that projects from a distal end of each of said ink fountain keys toward the ink fountain roller and guides the ink extracted from said ink fountain to the ink fountain roller.

2. An apparatus according to claim 1, further comprising a sheet that wholly covers a bottom surface of said ink fountain,
wherein a distal end of said sheet projecting from the distal end of each of said ink fountain keys forms said ink guide portion that bends downward and faces the outer peripheral surface of the ink fountain roller.

3. An apparatus according to claim 2, wherein said sheet comprises a waterproof sheet.

4. An apparatus according to claim 2, further comprising:
an ink fountain key support base unit that wholly supports said ink fountain keys and has an upper surface forming the bottom surface of said ink fountain;
a fixed member made of a magnetic metal; and
a magnet buried in said ink fountain key support base unit in correspondence with said fixed members,
wherein said sheet, arranged between said fixed member and said magnet, is fixed on the upper surface of said ink fountain key support base unit when said fixed member is magnetically engaged with said magnet.

5. An apparatus according to claim 4, wherein said fixed member wholly covers the bottom surface of said ink fountain except said ink fountain keys.

6. An apparatus according to claim 4, wherein said ink fountain key support base unit comprises an ink fountain key support base and a holding bar which is attached to said ink fountain key support base in the shaft direction of the ink fountain roller, and
said magnet is buried in at lease one of said said ink fountain key support base and said holding bar.

7. An apparatus according to claim 1, further comprising an ink guide member integrally fixed to an end face of the distal end of each of said ink fountain keys,
wherein said ink guide portion is provided on said ink guide member in state of facing the outer peripheral surface of the ink fountain roller.

8. An apparatus according to claim 1, further comprising a roller arranged immediately under said ink guide portion to contact the ink fountain roller.

9. An apparatus according to claim 1, wherein said ink guide portion has an opposing surface that faces the outer peripheral surface of the ink fountain roller and has a circumferential length of about 5 to 15 mm.
